(19) United States
(12) Patent Application Publication
(10) Pub. No.: US 2019/0386364 A1
(43) Pub. Date: Dec. 19, 2019

(54) ANGLE OF INCIDENCE-STABLE FREQUENCY SELECTIVE SURFACE DEVICE

(71) Applicants: Edward Liang, San Diego, CA (US); Te-Kao Wu, Rancho Palos Verdes, CA (US)

(72) Inventors: Edward Liang, San Diego, CA (US); Te-Kao Wu, Rancho Palos Verdes, CA (US)

(21) Appl. No.: 16/008,305

(22) Filed: Jun. 14, 2018

(51) Int. Cl. H01P 1/20; H01Q 19/02; H01Q 5/30

(52) U.S. Cl. CPC H01P 1/20; H01Q 5/30; H01Q 19/02

(57) ABSTRACT

Resonant frequency stability of passbands or stopbands is provided over varying incidence angles and polarizations in a dual band frequency selective surface (FSS) device. The FSS device comprises an array of fractal unit cells. The fractal elements may comprise single fractal, or double fractal, or convoluted, or split ring resonator slot elements printed on a thin dielectric substrate. Each cell includes a first fractal pattern and a second fractal pattern which interact to provide the improved performance. In one form, a two-screen fractal FSS is etched on both sides of a thin dielectric substrate. The top FSS screen's unit cell has one fractal loop patch element, while the bottom FSS screen's unit cell has a higher order iteration of the same fractal. In another form, two fractal screens are incorporated in one dielectric layer positioned between two substrate layers. In yet another form, two fractal loop slot element FSSs are provided.

### CROSS REFERENCE TO RELATED APPLICATIONS

This application claims priority to U.S. Provisional Patent Application Ser. No. 62/530,811, which is incorporated herein by reference in its entirety.

### FIELD

The present subject matter relates generally to frequency selective surface devices, primarily filters and antennas.

### BACKGROUND

A frequency-selective surface (FSS) is a thin, repetitive surface designed to reflect, transmit, or absorb electromagnetic fields based on the frequency of the field. Separation of radio frequency (RF) signals into their component frequency parts may be achieved by establishing pass bands or stop bands. Separation is achieved by the action of a regular, periodic pattern on the surface of an FSS. The pattern is usually metallic. Response of an FSS may change as a function of incidence angle and polarization. Frequency-selective surfaces have been most commonly used in the radio frequency region of the electromagnetic spectrum and find use in applications as diverse as the microwave oven, antenna radomes, and modern metamaterials. Current considerations are discussed in the context of a spatial filter operating in open space.

Sometimes frequency selective surfaces are referred to simply as periodic surfaces and are a 2-dimensional analog of the new periodic volumes known as photonic crystals. FSSs are used in many communications applications. A new and growing area is 5G communications. These and other applications are used over a wide range of frequencies. In some ranges within these frequencies, a reliable filter must be used to comply with stringent spectrum requirements or to solve particular problems. For example, hospitals may use life-support instruments subject to interference from Wi-Fi systems. An FSS filter can block noise from being introduced to the life-support instruments.

Wi-Fi systems generally operate in both the 2.4 and 5 GHz bands and are used to cover indoor environments such as hospitals, high-rise buildings, and offices. Noise induced by unwanted outside electromagnetic interference (EMI) may cause life-support instruments to malfunction, endangering patients' lives. A traditional miniature fractal patch element FSS for a Wi-Fi system may exhibit a stable first resonant frequency at 2.4 GHz at various incident angles and polarizations. However, the second resonant frequency in the 5 GHz band is generally not stable, making it difficult to block Wi-Fi signals in both bands. A similar problem is observed in a Wi-Fi FSS design using multi-ring elements.

A very important area of consideration is 5G communications. The advent of 5G wireless communication includes a rapid growth of connectivity for a large number of devices and a huge increase in mobile data rates. Networks are required to support 1000× higher data volume per area, 10 to 100× more connected devices in real-time, and 10 to 100× higher data rate. To deal with stringent spectrum requirements, spatial filters are usually required. The design of multi-band spatial filters or FSS filters can be very challenging due to requirements for stable filtering performance with changes in incident angle and polarization.

The most common FSS is a two-dimensional periodic array of either thin conducting or aperture, e.g., slot, elements etched on a flat or curved dielectric structure. Various FSSs with cross dipole patch elements have been used in multi-band communication systems. However, the transmission performance changes drastically as the incident angle is steered from normal to 40 degrees. Thus, a large stop-to-passband ratio or band separation ratio is required to minimize radio frequency (RF) losses. This is evident in a stop-to-passband ratio of 7:1 for a single screen FSS or 4:1 for a double screen FSS. Many FSSs exhibit frequency stability with varying incident angles and polarizations at a first resonant frequency. The FSSs' performances are unstable at a second resonant frequency occurring closer to the grating lobe region.

Another significant application of FSS devices is in radar to protect communication/radar antenna systems behind or enclosed inside a radome. Much of the work for stabilizing FSS resonant frequencies has been through the use of cross or hexagonal loop slot elements and complementary type miniature element FSSs (MEFSS) for bandpass radome applications. Response of FSS elements will vary with angle of incidence. In the prior art waves incident on antennas tend to be within ±45°. In GEO satellite communications, wave incidence tends to be closer to normal.

An FSS device is incorporated in a radome in an antenna array's aperture to pass the desired signal while blocking noise. In one exemplary application, a quasi-optical FSS filter passes an in-band signal from 20.2 to 21.2 GHz. The antenna arrays' high-power amplifiers generate harmonics from 43.5 to 45.5 GHz. The FSS filter blocks the harmonics, which are out-of-band. Also, although stability of the passband center frequency can be achieved over various incident angles and polarizations, bandwidth is generally decreased for transverse-magnetic (TM) polarization or increased for transverse-electric (TE) polarization. Greater band separation ratio than what is currently available is still desired for advanced communication or radar antenna systems.

Further definition and description of modes of polarization are provided in R. F. Harrington, Time-Harmonic Electromagnetic Fields, (McGraw-Hill, N.Y., 1961) and C. A. Balanis, Advanced Engineering Electromagnetics, 2nd Ed., (John Wiley and Son, Inc., N.Y., 2012). Frequency selective surface with circular ring elements are discussed at, Huang, John, Wu, Te-Kao, and Lee, Shung-Wu, “Tri-Band Frequency Selective Surface with Circular Ring Elements,” IEEE Transactions on Antennas and Propagation, vol. 42, No. 2, 1994, pp. 166-175.

U.S. Pat. No. 7,999,754 discloses an antenna with a ground plane or ground counterpoise system including an element whose shape, at least in part, is substantially a deterministic fractal of iteration order N≥2. This system requires the use of feeding striplines with attendant issues of impedance matching and interference. This patent does not disclose a passive device for spatial filter applications.

U.S. Pat. No. 7,019,695 discloses an antenna system including an element that includes a fractal element that may be a fractal counterpoise or a microstrip patch element. The driven element is fabricated on the first surface of the substrate. The substrate may be a nonconductive film. This patent does not disclose a passive device for spatial filter applications.

U.S. Pat. No. 7,688,279 discloses a body partially or entirely comprising a three-dimensional fractal structure. The fractal structure body has a local minimum value at a particular wavelength determined by structural and material factors of the fractal structure. The three-dimensional structure presents difficulties in manufacturing.

U.S. Pat. No. 7,420,524 discloses a reconfigurable frequency selective surface including a plurality of conducting patches supported on the surface of a dielectric layer arranged in a plurality of fractal arrays. Selectable electrical interconnections between the conducting patches provide for a reconfigurable FSS. A reconfigurable artificial magnetic conductor (AMC) includes a dielectric layer, a conducting back-plane on one surface of the dielectric layer, and a reconfigurable FSS on the other surface of the dielectric layer. A control circuit must be provided for reconfiguring the FSS. Dual band operation cannot be obtained from a single configuration.

U.S. Pat. No. 6,525,691 discloses an antenna with a ground plane that is perpendicular or parallel to the substrate. A bias voltage applied across the substrate can tune the antenna. An antenna uses a fractal pattern that has a plurality of segments arranged in a first configuration and a switch disposed to alter the first configuration to one or more other configurations. This antenna requires control circuitry to define a configuration. This patent does not disclose a passive device for spatial filter applications.

U.S. Pat. No. 7,088,965 discloses a method and system having one or more fractal antennas for communicating signals. The fractal antennas are coupled to a diversity receive circuit. The diversity receive circuit provides an output signal based on a combination of the receive signals. The fractal antennas and the diversity receive circuit can help reduce the effects of fading. This structure is not directed to improving bandwidth. This patent discloses an antenna, but does not disclose a passive device for spatial filter applications.

United States Published Patent Application No. 20030142036 discloses a frequency selective surface including meandering line inductors formed within the pattern of electromagnetic materials. A highly meandering fractal ground plane structure may provide additional inductance. In addition, the pattern of electromagnetic materials may be formed within the substrate in such a manner that the frequencies ARE tunable. This patent requires an unusual construction, adding complexity in design and manufacture.

U.S. Pat. No. 9,620,853 discloses methods and apparatus producing enhanced radiation characteristics, e.g., wideband behavior, in or for antennas and related components by providing concentric sleeves including conductive layers, at least a portion of which includes fractal resonators closely spaced, in terms of wavelength. Concentric sleeves rather than fractal structure are used to provide the enhanced characteristics. This patent discloses an antenna, but does not disclose a passive device for spatial filter applications.

U.S. Pat. No. 8,405,552 discloses a multi-resonant broadband antenna constructed with a dielectric substrate. A fractal radiation element having a predetermined fractal grid structure is adhered to an upper surface of the dielectric substrate. A feed line must be adhered on the upper surface of the dielectric substrate to feed the fractal radiation element. Having a feedline that must be adhered to the upper surface reduces design options for placement of the radiation elements. This patent discloses an antenna, but does not disclose a passive device for spatial filter applications

Wang, W. T., Zhang, P. F., Gong, S. X., Lu, B., Ling, J. and Wan, T. T. (2009), Compact Angularly Stable Frequency Selective Surface Using Hexagonal Fractal Configurations. Microw. Opt. Technol. Lett., 51: 2541-2544. doi:10.1002/mop.24676, http://onlinelibrary.wiley.com/doi/10.1002/mop.24676/epdf, discloses a compact bandstop frequency selective surface (FSS) using a fractal structure so that cell size gets smaller at the same resonant frequency. The unit cells comprise a known structure including regular hexagons. The array has an equilateral triangle form. This configuration is not truly symmetrical in x-y dimensions. This FSS is restricted to patch elements and a single stop band. Slot elements and dual band applications are not disclosed. Resonant frequency is changed by changing permitivity and not by structure.

Lee, In-Gon, and Ic-Pyo Hong, “Scalable Frequency Selective Surface with Stable Angles of Incidence on a Thin Flexible Substrate,” International Journal of Antennas and Propagation, vol. 2016, 2016, pp 1-6., doi:10.1155/2016/6891065, https://www.hindawi.com/journals/ijap/2016/6891065/, discloses a bandstop scalable frequency selective surface (FSS) structure that provides stability for an angle of incidence and polarization. This FSS uses a repetitive arrangement of a unit structure miniaturized on a dielectric substrate. This FSS structure possesses stable frequency response characteristics for a single frequency band but cannot be used for dual band applications.

### SUMMARY

The present subject matter provides resonant frequency stability in a bandstop filter over varying incident angles and polarizations in a miniature fractal patch element FSS. In addition, to meet the wide passband demand of 5G wireless communication systems, a fractal slot element FSS is designed and demonstrated to have more than 30 percent bandwidth with an insertion loss less than 0.5 dB. The filter's bandwidth is constant as the incident angle increases up to 60 degrees for both TE and TM polarizations. Also, a band separation ratio close to 1, i.e., a sharp transition from the passband to the rejection band or vice versa.

Briefly stated, in accordance with the present subject matter, resonant frequency stability in a bandstop or bandpass filter is provided by an array of fractal elements over varying incidence angles and polarizations. The fractal elements may comprise single fractal, or double fractal, or convoluted, or split ring resonator slot elements printed on a thin dielectric substrate. Each cell includes a first fractal pattern and a second fractal pattern which interact to provide the improved performance of the present subject matter.

In another exemplary embodiment, a two-screen fractal FSS is etched on both sides of a thin dielectric substrate. The top FSS screen's unit cell has one fractal loop patch element, while the bottom FSS screen's unit cell has a higher order iteration of the same fractal, e.g., four (2×2) fractal loop patch elements. These two screens have the same period. The fractal patterns are in horizontal registration. In another exemplary embodiment, two fractal screens are incorporated in one dielectric layer. The dielectric layer is positioned between two substrate layers. In yet another exemplary embodiment, two fractal cross or hexagonal loop slot element FSSs are provided.

The design and analyses of the patch and slot FSS filters are based on an accurate integral equation formulation (IEF) combined with the method of moments (MOM). This analytical approach is also known as the full wave analysis technique. The accuracy of this numerical approach has been verified by many comparisons with measured data.

The present subject matter provides for stability of passbands and stopbands with respect to angle of incidence for dual band and wide band applications. While the prior art is generally limited to stability for angles of incidence up to ±45°. The structure of the present subject matter allows for stability for angles of incidence up to ±60°.

### BRIEF DESCRIPTION OF THE DRAWINGS

The present subject matter may be further understood by reference to the following description taken in connection with the following drawings:

FIG. 1A is a partial detailed view of a prior art FSS comprising an array of conductive patches to form a bandstop filter;

FIG. 1B is a partial detailed view of a prior art FSS including a periodic array of slots to form a bandpass filter;

FIG. 2A is an isometric view of a filter device;

FIG. 2B is a plan view of a of a nominal fractal layer;

FIG. 3A is a chart illustrating bandstop performance of the device of FIGS. 2A and 2B for TE polarization;

FIG. 3B is chart illustrating bandstop performance of the device of FIGS. 2A and 2B for TM polarization;

FIG. 4 is a chart illustrating two-band performance in a bandstop filter;

FIG. 5 is a diagram of signal feed in an FSS subreflector;

FIG. 6 is an isometric view of an array antenna using horn feeds;

FIG. 7 is an isometric view of an FSS constructed in accordance with the present subject matter;

FIG. 8 is a side view of the device of FIG. 7;

FIG. 9 is a plan view of one preferred form of upper fractal layer;

FIG. 10 is a plan view of one preferred form of lower fractal layer;

FIG. 11 is a chart illustrating bandstop performance of the device of FIG. 7 for TE polarization;

FIG. 12 is a chart illustrating bandstop performance of the device of FIG. 7 for TM polarization;

FIG. 13 is a plan view of a unit cell configuration of a double fractal elements FSS;

FIG. 14 is a side view of the device of FIG. 13;

FIG. 15 is a chart illustrating bandstop performance of the device of FIG. 13 for TE polarization;

FIG. 16 is a chart illustrating bandstop performance of the device of FIG. 13 for TM polarization;

FIG. 17 is a plan view of the two-screen fractal slot element FSS;

FIG. 18 is a side view of the device of FIG. 17;

FIG. 19 is a chart illustrating bandpass performance of the device of FIG. 16 for TE polarization; and

FIG. 20 is a chart illustrating bandpass performance of the device of FIG. 16 for TM polarization.

### DETAILED DESCRIPTION

A frequency-selective surface (FSS) is a repetitive surface designed to reflect, transmit, or absorb electromagnetic fields based on the frequency of the field. FSSs exhibit frequency filtering properties similar to those of frequency filters in traditional radio frequency (RE) circuits. Typically, an ESS is a two-dimensional structure comprising two-dimensional periodic elements. An FSS may comprise a band stop filter rejecting waves at a resonant frequency but passing them at higher and lower frequencies. Alternatively,an FSS may comprise a bandpass filter passing waves at a resonant frequency but rejecting them at higher and lower frequencies.

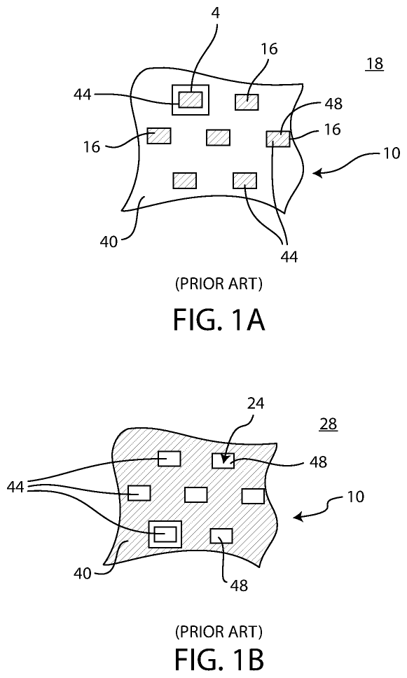

Prior art fractal patch element FSS designs specifically address modern, multi-band wireless local area networks (WLAN), i.e., Wi-Fi systems, that generally operate in both the 2.4 and 5 GHz bands and are used to cover indoor environments such as hospitals, high-rise buildings, and offices. Noise induced by unwanted outside electromagnetic interference (EMI) may cause life-support instruments to malfunction, endangering patients' lives. To reduce or eliminate interference from nearby Wi-Fi systems, the Wi-Fi signals must be confined within specific physical areas. A traditional miniature fractal patch element FSS for a Wi-Fi system may exhibit a stable first resonant frequency at 2.4 GHz at various incident angles and polarizations. However, the second resonant frequency in the 5 GHz band is generally not stable, making it difficult to block Wi-Fi signals in both bands. A similar problem is observed in a Wi-Fi FSS design using multi-ring elements. The prior art is further discussed with respect to FIG. 1A through FIG. 4.

FIG. 1A is a partial detailed view of a prior artFSS 10 comprising an array of conductive fractal patches 16 to form a bandstop filter 18. The bandstop filter 18 rejects waves and passes waves at higher and lower frequencies. FIG. 1B is a partial detailed view of a prior art FSS 10 including a periodic array of aperture elements 24 to form a bandpass filter 28. Aperture elements 24 normally comprise slots. The periodic array of slots passes waves at a resonant frequency, but rejects waves at higher and lower frequencies. The filtering property facilitates use of FSS reflectors to separate feeds of different bands. FSSs are also used as antenna radomes for control of transmitted and reflected electromagnetic waves. These figures are discussed together. In FIG. 1A and FIG. 1B, the same reference numerals are used to denote corresponding elements.

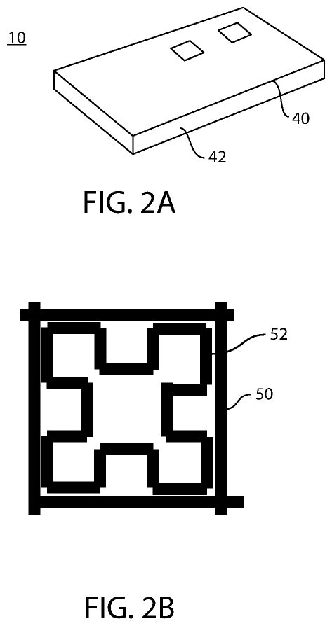

Each FSS 10 comprises a surface 40 formed on a substrate 42 (FIG. 2A), An array of periodical cells 44 is provided on each surface 40. Each periodical cell 44 includes a fractal element 48. In the bandstop embodiment of FIG. 1A, the fractal element 48 comprises the conductive patch 16. In the bandpass embodiment of FIG. 1B, the fractal element 48 comprises the slot, or aperture, 24,

FIG. 2A is an isometric view of a FSS device 10. The surface 40 is formed on the substrate 42. Proportions of the thickness of the substrate 42 to the thickness of the surface 40 are selected in accordance with desired performance characteristics. FSSs may also be categorized as thick or thin-screenFSS, depending on the thickness of the element. The term thin-screen FSS usually refers to a screen with printed-circuit type elements, specifically, patch or aperture elements with thickness less than 0.001λ. (wavelength) of the screen's resonant frequency. In general, the thin-screen FSS is light in weight, low-volume, and inexpensive, capable of being fabricated with conventional printed-circuit technology. On the other hand, a thick-screen FSS is used mostly for bandpass applications with aperture elements in a periodic array with electrically large thickness. In the case of freestanding and thin grids without dielectrics, the filtering performances of the patch elements and aperture elements are exactly complementary to each other. Because of this filtering property, there are two major applications of FSS. One is in reflector antenna systems, where FSS reflectors are used to separate feeds of different bands. The other application is to use FSS as antenna radomes for better control of the transmitted and reflected electromagnetic waves.

FIG. 2B is a detailed plan view of a nominal patch fractal element 16 as included in the bandstop filter 18 of FIG. 1A. Many different forms of fractals are available. One preferred form of fractal is based on a square. Different forms of fractals are chosen for performance in accordance with their respective characteristics. The embodiment illustrated in FIG. 2B comprises a gridded fractal element unit cell. The cell comprises a square grid 50 surrounding a Minkowski fractal element unit cell 52. Minkowski fractals are useful in the design of surfaces which exhibit two or three stopbands depending on how many iterations are used to generate the geometry of the cell. In one preferred form, the fractal element cell 50 comprises a square.

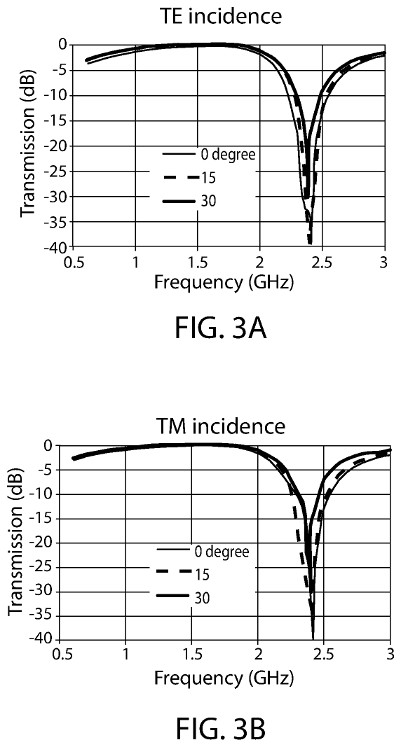

In FIG. 3A and 3B the abscissa is frequency and the ordinate is transmission amplitude in decibels (dB). These Figures illustrate a stopband at 2.4 GHz.

FIG. 3A is a chart illustrating bandstop performance of the device of FIGS. 2A and 2B for TE polarization. FIG. 3B is a chart illustrating bandstop performance of the device of FIGS. 2A and 2B for TM polarization.

The variation in response for varying angles of incidence is illustrated. The solid line indicates response at 0°. The dashed lines in FIG. 3A and FIG. 3B represent response at a 15° angle of incidence. The dotted lines represent response at 30°.

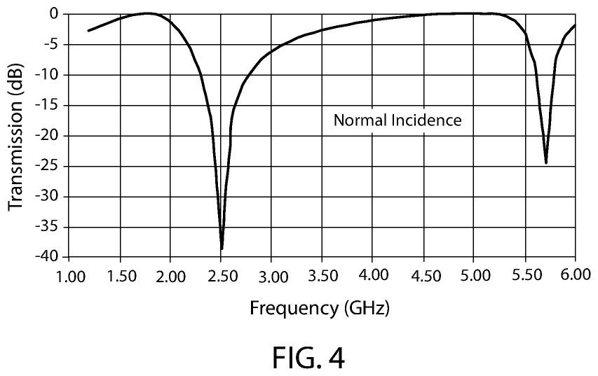

FIG. 4 is a chart illustrating a nominal response of a two-band bandstop filter. This response curve indicates stop bands at 2.5 GHz and at 5.7 GHz. This filter is used to reject both 2.4 GHz and 5 GHz wi-fi bands. The first stop band at 2.5 GHz remains stable at a range of variations from normal incidents. The 5.7 GHz stop band does not remain stable for significant variation for angle of incidence. The present subject matter minimizes this disadvantage.

In accordance with the present subject matter, fractal element designs interact within an FSS device. One benefit of these designs is to improve both the first and second resonant frequency stability with incident angle changing from normal to 60° and both TE and TM polarizations for both first and second home resident frequencies. More than one fractal pattern is incorporated in an FSS device to interact with another fractal pattern. The fractal patterns may be provided on opposite sides of the substrate. The fractal patterns may be concentric and on a single layer. In another embodiment, particularly suited to slot elements, the elements may be embedded in separate dielectric layers.

The design and analyses of the patch and slot FSS filters described in this article are based on an accurate integral equation formulation (IEF) combined with the method of moments (MOM). This analytical approach is also known as the full wave analysis technique. The accuracy of this numerical approach has been verified by many comparisons with measured data.

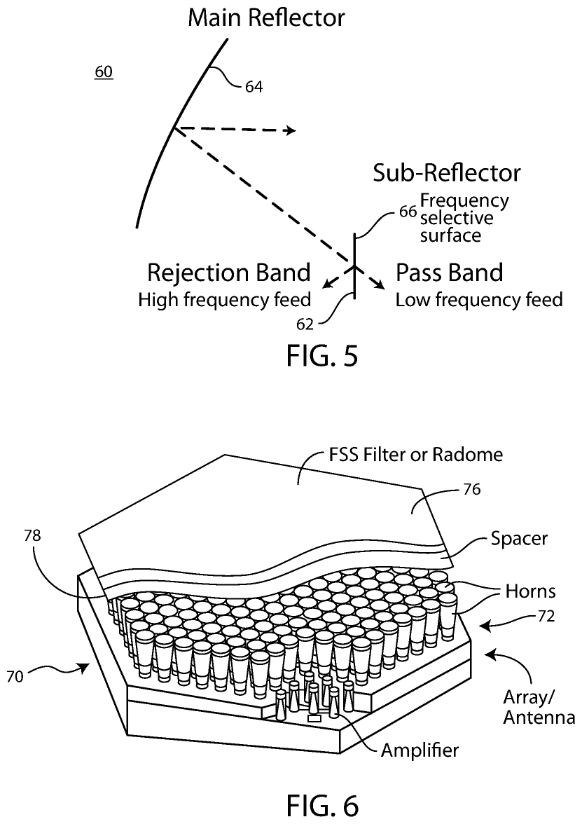

Both FIG. 5 and FIG. 6 illustrate prior art systems. The performance of these systems will be improved by incorporation of the present subject.

FIG. 5 is a diagram of dual reflector antenna system 60 including a signal feed in a multiplexing FSS subreflector 62. In the present illustration, a Satcom application is presented. The subreflector 60 cooperates with a main reflector 64. This FSS is useful as a multiplexing sub-reflector 62, or dichroic. The antenna system 60 is a high gain antenna system for multiband communication. In one commercial application a screen door of a microwave oven comprises a periodic array of metallic holes designed for reflecting microwave energies at 2.45 GHz while passing visible light. A user sees the interior of the microwave oven while being protected from microwave energies.

The subreflector 62 comprises an FSS 66. Different frequency feeds are optimized independently and placed at the real and virtual foci of the subreflector 62. Hence, only a single main reflector 64 is required for multifrequency operation. An example is the FSS on the high-gain antenna of the Voyager spacecraft which diplexed S and X bands. In that application the S-band feed is placed at the prime focus of the main reflector 64, and the X band feed is placed at the Cassegrain focal point. Only one main reflector 64 is required for this two-band operation.

FIG. 6 is an isometric view of an array antenna 70 using horn feeds 72 and a radome 76 incorporating an interference and shielding filter 78 for an advanced or low radar cross section (RCS) array/antenna systems 70. The radome 76 may comprise a tangent ogive surface, an ellipsoid surface, or other shape. The shielding filter 78 is a double-screen FSS filter with I-bar elements. The shielding filter 78 prevents interference from two X-band satellite communication (SATCOM) antennas in an application in which the x-band antennas are mounted nearby on a same shipborne platform. The shielding filter 78 comprises in another example a gridded-double-square-loop FSS (not shown). The shielding filter 78 prevents higher-order harmonics of a K-band high-power transmit phased array operating from 20.2 to 21.2 GHz, interfering the nearby Q-band antennas operating from 43.5 to 45.5 GHz and the V band 60-GHz cross-link antenna.

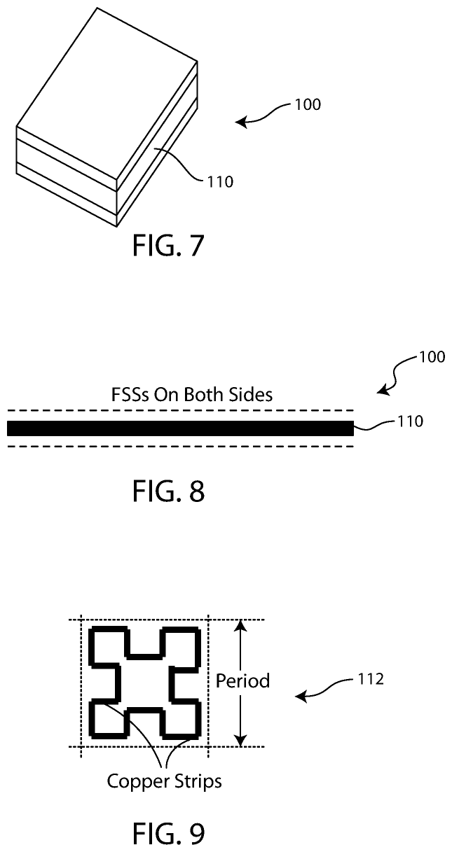

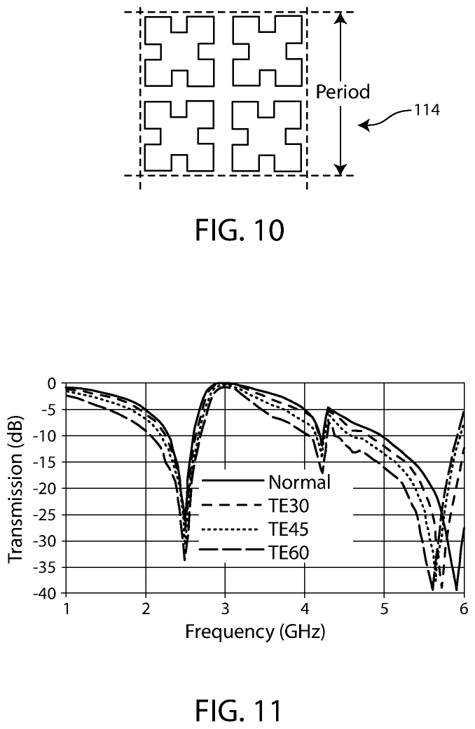

FIG. 7 is an isometric view of a two-screen fractal FSS device 100 including a dielectric substrate 110. The FSS device 100 provides for dual band operation. First and second stopbands are provided. FIG. 8 is an exploded elevation of the FSS device 100. FIG. 9 is a plan view of a basic cell 112 formed on an upper side of the dielectric substrate 110. FIG. 10 is a plan view of a cooperating cell 116 formed on a bottom side of the dielectric substrate 110. FIG. 7, FIG. 8, FIG. 9, and FIG. 10 are taken together. This embodiment provides for a common bandwidth for the TE and TM polarizations. In addition, angle of incidence stability is also provided for circular polarization. The FSS device may be constructed to operate in frequency ranges from communications to virtually optical frequencies.

The basic cell 112 and the cooperating cell 116 are placed in relationship to each other to provide near field coupling. A wave incident on the basic cell 112 is propagated to a next layer, i.e., the cooperating cell 116. Due to the near field coupling, the basic cell 112 influences the cooperative cell 116. The spacing between the layers provided by the dielectric substrate 110 provides for a separation allowing for near field coupling. The two layers formed by the basic cell 112 and the cooperating cell 116 act as a single device.

The substrate 110 is a thin dielectric substrate. The term thin-screen FSS usually refers to a screen with printed-circuit type elements, specifically, patch or aperture elements with thickness less than 0.001 (wavelength) of the screen's resonant frequency. In the present illustration, the substrate 110 comprises an RT/duroid® 6006 substrate with dielectric constant equal to 6. RT/duroid® 6006 microwave laminates are ceramic-PTFE composites designed for electronic and microwave circuit applications requiring a high dielectric constant.

The basic unit cell 112 is comprised of fractal elements 108. In a bandstop embodiment, each fractal element 108 includes a conductive patch element 104, which could comprise copper. The basic cell 112 has a first resonant frequency to provide a first stopband. The cooperating cell 116 has a second resonant frequency, which is substantially a multiple of the first resonant frequency. To obtain the higher resonant frequency, the cooperating cell 116 needs to have a fractal pattern half the length of the pattern for the lower frequency. An integral number of fractal patterns in the cooperating cell 116 is provided for cooperating with the single fractal pattern in the basic cell 112.

In one nominal 5G communications application for blocking Wi-Fi signals, the FSS device 100 requires a first stopband of 2.4 GHz and a second stopband for the 5-6 GHz band. The basic cell 112 is provided to have a 2.4 GHz stopband. The cooperating cell 116 has approximately 2× the resonant frequency of the basic cell 112. Therefore, the cooperating cell 116 has four, i.e., 2×2, fractal loop patch elements. The cells 112 and 116 screens have the same period, and their unit cells must be aligned “exactly” with each other. “Exactly” is within a preselected tolerance. A preselected tolerance is chosen as an optimization between device performance and cost. Another FSS device 100 having a second resonant frequency which is 3× the first resonant frequency will have a cooperating cell 116 with a pattern of 3×3, or 9, fractal loop patch elements. Filters can be cross-coupled to manipulate signal rejection.

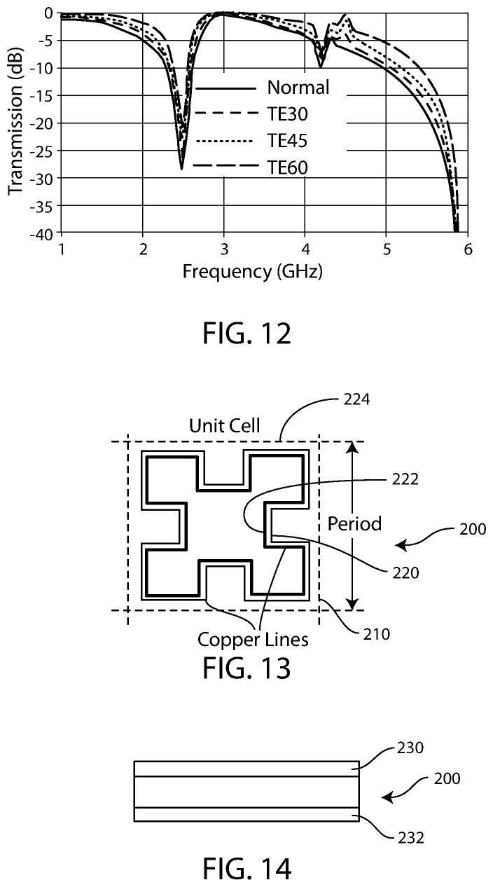

The transmission performance is given in FIG. 11 and FIG. 12. In both FIG. 11 and FIG. 12, the solid curve represents performance at normal incidence. The short-dashed curve represents incidence at 30 degrees. The dotted line represents incidents at 45 degrees. The long-dashed line represents incidence at 60 degrees.

Transmission performance is shown in FIG. 11 and FIG. 12 for the RT/duroid 6006 substrate with a dielectric constant of 6. Performance for the TE polarization is illustrated in FIG. 11. Performance for the TM polarization is illustrated in FIG. 12. As the incident angle changes from normal to 60 degrees, the FSS provides at least 18 dB attenuation at both 2.45 and 5.8 GHz for both TE and TM polarizations.

FIG. 13 and FIG. 14 illustrate an embodiment in an FSS device 200 in which two fractal elements are included in a screen 210. FIG. 13 is a plan view of the screen 210 in the FSS device 200. FIG. 14 is a side view of the device 200. FIG. 13 and FIG. 14 are taken together. This embodiment comprises the single FSS screen 210 with two concentric fractal loop, or double fractal, patch elements 220 and 222 in a unit cell 224. The FSS screen 210 is sandwiched between two dielectric slabs 230 and 232. The dielectric slabs 230 and 232 each have a dielectric constant of 2.2 and thickness of 3 mm. The period of the unit cell 224 is 2 cm.

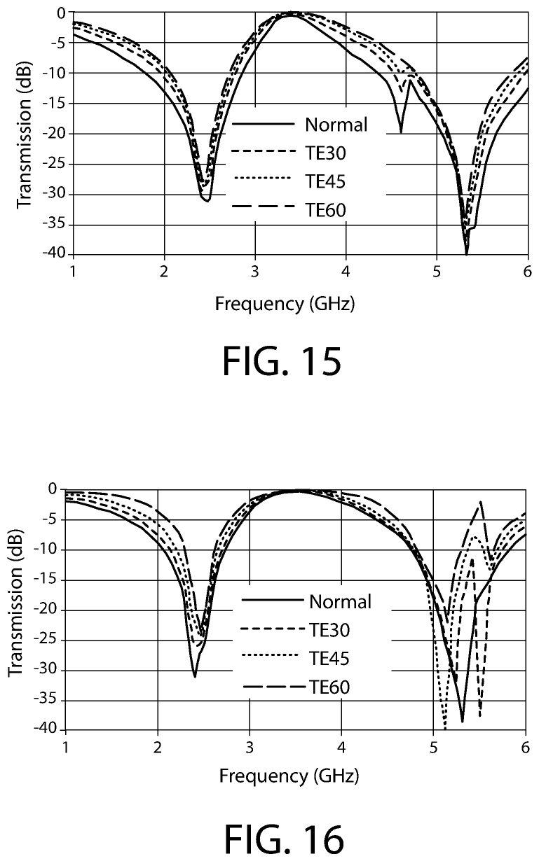

FIG. 15 is a chart illustrating bandstop performance of the device of FIG. 13 for TE polarization. FIG. 16 is a chart illustrating bandstop performance of the device of FIG. 13 for TM polarization. At 2.45 and 5.2 GHz, at least 18 dB of attenuation is obtained for both TE and TM polarizations over incident angles varying from normal to 60 degrees. The transmission performance is given in FIG. 15 and FIG. 16. In both FIG. 15 and FIG. 16, the solid curve represents performance at normal incidence. The short dashed curve represents incidence at 30 degrees. The dotted line represents incidents at 45 degrees. The long dashed line represents incidence at 60 degrees.

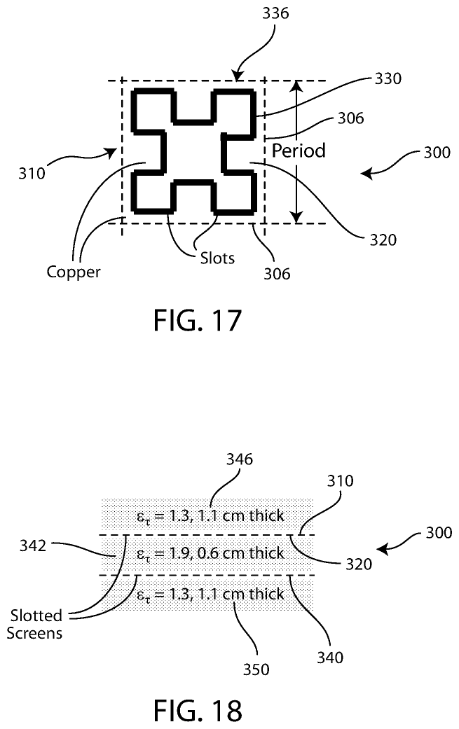

FIG. 17 and FIG. 18 illustrate an embodiment to provide a wider passband. FIG. 17 and FIG. 18 are taken together. This structure provides for a TM-TE bandwidth overlap of 34% bandwidth. An FSS device 300 has fractal elements 310 each comprising slots 308. The slots 308 are each formed, generally etched, in a metallic sheet, or metallization layer, 306. The metallic sheet, or metallization layer, 306 comprises a ground plane. The fractal loop slots 308 are formed in a copper screen 320. The fractal elements 310 are each included in a unit cell 330. FIG. 17 is a plan view of the screen 320 in the FSS device 300. FIG. 18 is a side view of the device 300.

The fractal loop slots 308 in the FSS device 300 provide wider bandwidth. The 0.5 dB passband bandwidth is about 34 percent, which is greater than prior art embodiments for both TE and TM polarizations, as well as incident angles varying from normal to 60 degrees. Further sharpened roll-off skirts are provided by a second slotted screen 340 (FIG. 18). The screens 320 and 340 are spaced by a center dielectric layer 342. The screen 320 is disposed between the center dielectric layer 342 and a top dielectric layer 346. The screen 340 is disposed between the center dielectric layer 342 and a bottom dielectric layer 350. The limit of the distance by which the screens may be separated will be determined by impedance matching.

The two-screen embodiment of FIG. 17 provides for angle of incidence stability of ±60°. This effect is particularly important in achieving wideband radome applications. This construction can provide 30% bandwidth overlap for the TE and TM modes.

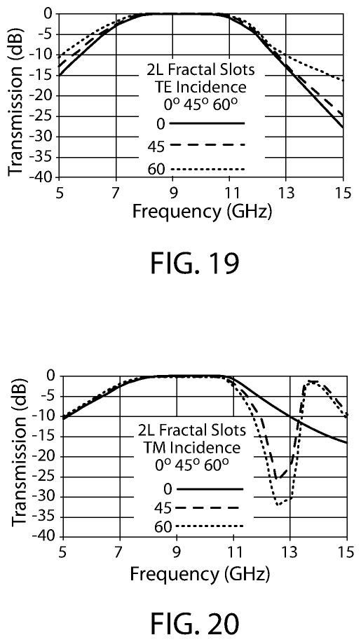

FIG. 19 is a chart illustrating bandpass performance of the device of FIG. 17 for TE polarization. FIG. 20 is a chart illustrating bandpass performance of the device of FIG. 18 for TM polarization. In both FIG. 19 and FIG. 20, the solid curve represents performance at normal incidence. The dashed curve represents incidence at 45 degrees. The dotted line represents incidence at 60 degrees.

Novel FSS filters with miniature fractal patch elements have been designed in accordance with the present subject matter for 5G multi-band wireless communications. 5G promises to deliver data 100 times faster than today's LTE network with 1 ms latency. The present subject matter is a step toward achieving these capabilities. Benefits of the present subject matter in 5G multi-band wireless communications include reduced unwanted or hostile RF interference, wider pass-band band-width, and ease and low cost in fabrication and assembly. These benefits contribute to addressing latency in 5G communications. These benefits facilitate the ability of a network to be accessed anywhere and anytime and be completely transparent to end users. The present subject matter is compatible with higher frequency bands such as mm Wave bands, massive multiple-input/multiple-output (MIMO), and beamforming.

A fractal slot element FSS was designed and demonstrated to have greater than 30 percent bandwidth with an insertion loss less than 0.5 dB for wideband antenna/radomes. Both patch and slot FSSs exhibit angular stability and polarization independent features as the incident angle is varied from normal to 60 degrees. They are low volume, lightweight and can be easily fabricated with conventional printed circuit board techniques. These designs may also be scaled to THz and infrared frequency bands. The present subject matter will find a myriad of applications in advanced communication and radar systems.

The above description is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. A wide range of systems may be provided consistent with the principles and novel features disclosed herein.

1. A frequency selective surface (FSS) device comprising:
a periodic array of fractal cells having a preselected period;
wherein individual fractal cells comprise:
a first fractal loop in a first surface;
a second fractal loop in a second surface;
a fractal unit cell size defining a period,
each fractal unit cell comprising a plurality of fractal elements, said fractal elements being disposed to form a fractal;
a dielectric layer; and
said first fractal loop and said second fractal loop being positioned with respect to said dielectric layer to permit mutual interaction and disposed in a preselected mutual alignment.

2. A device according to claim 1 wherein each said fractal element comprises a conductive patch element.

3. A device according to claim 1 wherein said first and second fractal loops are etched on opposite sides of said dielectric layer, said first fractal loop comprising a selected iteration of a base shape and said second fractal loop comprising a higher order fractal iteration of the base shape and having a plurality of second fractal loops in a cell.

4. A device according to claim 3 wherein said base shape is a square.

5. A device according to claim 4 wherein said first fractal loop and said second fractal loop are aligned to be concentric.

6. A device according to claim 2 wherein said first fractal loop and said second fractal loop are included in a single cell and are concentric.

7. A device according to claim 6 wherein the cell is disposed between two dielectric slabs.

8. A device according to claim 1 wherein each said fractal element is a slot etched in a metallic sheet.

9. A device according to claim 8 comprising a first metallic sheet disposed between a first dielectric layer and a second dielectric layer.

10. A device according to claim 9 further comprising a second metallic sheet and a third dielectric layer wherein said second metallic sheet is disposed between said second dielectric layer and said third dielectric layer.

11. A method for stabilizing resonant frequencies in a dual band frequency selective surface device comprising:
providing a first fractal loop and a second fractal loop, said first fractal loop and said second fractal loop being positioned to interact in response to incident radiation on the frequency selective surface device; and
selectively transmitting or stopping the incident radiation.

12. A method according to claim 11 further comprising transmitting transverse magnetic (TM) or transverse electric (TE) radiation, whereby amplitude response of said frequency selective surface device to the transverse magnetic (TM) polarization or transverse electric (TE) polarization is substantially independent of angle of incidence.

13. A method according to claim 11 further comprising directing circularly polarized radiation, whereby amplitude response of said frequency selective surface device to the circular polarization of the incident radiation is substantially independent of angle of incidence and wherein the TM and TE responses have overlapping bandwidths.

14. A fractal cell comprising:
a first fractal loop in a first surface;
a second fractal loop in a second surface;
said first fractal loop and said second fractal loop, each having fractal unit cell size defining a period,
each fractal unit cell comprising a plurality of elements, said elements being disposed to form a fractal; and
a dielectric layer.

15. A device according to claim 14 wherein each said fractal element comprises a conductive patch element.

16. A device according to claim 15 wherein said first and second fractal loops are etched on opposite sides of said dielectric layer, said first fractal loop comprising a selected iteration of a base shape and said second fractal loop comprising a higher order iteration of the base shape and having a plurality of second fractal loops in a unit cell.

17. A device according to claim 15 wherein said first fractal loop and said second fractal loop are included in a single cell and are concentric and wherein said first and second surfaces are coplanar.

18. A device according to claim 14 wherein each said fractal element is formed in a first conductive layer and comprises a slot.

19. A device according to claim 18 wherein said first conductive layer is disposed between a first dielectric layer and a second dielectric layer and further comprising a second conductive layer and a third dielectric layer wherein said second conductive layer is disposed between said second dielectric layer and said third dielectric layer.

20. A device according to claim 14 further comprising a radome and wherein said frequency selective surface device is disposed in a radiation path in said radome.
